(19) United States
(12) Patent Application Publication
(10) Pub. No.: US 2009/0299809 A1
(43) Pub. Date: Dec. 3, 2009

(54) SYSTEM AND METHOD TO ALLOW AN END USER TO CREATE AND MAINTAIN A SUB WORKFLOW

(75) Inventors: Paolo Dettori, Hartsdale, NY (US); Julio Nogima, Tarrytown, NY (US); Frank A. Schaffa, Hartsdale, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/131,488

(22) Filed: Jun. 2, 2008

(51) Int. Cl. G06Q 10/00

(52) U.S. Cl. 705/9

(57) ABSTRACT

A first party, such as a service provider maintains a workflow, and defines at least one access point therein. The first party obtains, from a second party, such as an end user, a specification of at least one sub workflow, for insertion at the access point. The first party runs the workflow. The first party obtains, from the second party, an indication of identity of the second party. During the processing of the workflow, the first party executes the sub workflow, when the access point is reached, based on the indication of identity of the second party. The processing of the workflow thus produces a customized result for the second party.

### FIELD OF THE INVENTION

The present invention relates to the electrical, electronic and computer arts, and, more particularly, to workflows in information technology (IT) and the like.

### BACKGROUND OF THE INVENTION

Digital media content is becoming more and more pervasive in information technology. Digital media content includes (but is not limited to) pictures, audio, video and associated metadata. The importance of media is directly related to how usable the content in the target environment is; that is, content should be easily searchable, in order to locate the desired fragment, and content should be in the proper format for the target environment. In addition, digital media needs some processing and transformation to achieve the desired result. Such processing may be achieved by running a workflow.

Note that workflows can be associated with many systems and processes; digital media is but one example. In current techniques, a workflow system is out-of-scope from the end user.

U.S. 2005-0033626 discloses a universal worklist service and user interface. Work items are collected from one or more work item providers for presentation to a workflow participant. A work item provider is typically a workflow management system (“WFMS”), but other providers of work items might exist that generate work items and may or may not have their own local worklist. Multiple independent WFMS's of multiple types might provide work items to a universal worklist (“UWL”) service that integrates the work items from all of the providers. Additional integration might be provided between the UWL and work item providers, such as for controlling work item execution with a sub workflow through an ad-hoc workflow engine. Additional integration provides for custom attributes. Each work item has a type that is used to determine handling for that work item. A universal work list service includes storage for work items, wherein a work item represents a task generated as part of a process flow. An engine supporting the UWL service might track item types for work items and might obtain attribute values for attributes of the work item according to the work item's type.

U.S. 2002-0046072 discloses a workflow system. The workflow system includes a sub workflow define means for defining a sub workflow which determines a workflow within a section and a sub workflow interface part disposed at every section, the sub workflow interface part having a definition of a correspondence of sub workflow used according to the data. Data is transferred via the sub workflow interface part disposed at the section units. When the sub workflow interface part receives data, a sub workflow corresponding to the received data is activated so that a route can be defined at every section, thereby making it easy to define a route. Therefore, when a change occurs in a section of a route is changed in somewhere of the section, the route may be defined again within that section, and the route can be changed easily. Also, data sequentially flows among the respective sections via the sub workflow interface part so that a continuity of a work processing among the sections can be maintained.

U.S. 2006-0195575 discloses techniques for determining a user's groups. In particular, this reference is directed to technology for determining the set of groups of which a user is a member. A user can be a static member, dynamic member or nested member of a group. A user is a nested member of a first group if that user is a member of a second group and the second group is a member of the first group. There can be multiple levels of nesting. For example, an entity can be a nested member of a first group if that entity is a member of a second group, which is a member of a third group, which is a member of a fourth group, which is a member of the first group. The techniques can determine the groups of which the user is a static member, dynamic member or nested member.

### SUMMARY OF THE INVENTION

Principles of the present invention provide techniques for allowing a party, such as an end user, to create and maintain a sub workflow. In one aspect, an exemplary method (which can be computers implemented) includes the steps of: maintaining, by a first party, such as a service provider a workflow; defining, in the workflow, at least one sub workflow access point; and obtaining, from a second party, such as an end user, a specification of at least one sub workflow, for insertion at the access point. Additional steps include processing, by the first party, the workflow; obtaining, by the first party from the second party, an indication of identity of the second party; and during the processing of the workflow, executing the sub workflow, by the first party, when the access point is reached, based on the indication of identity of the second party. The processing of the workflow thus produces a customized, useful, concrete, and tangible result for the second party, since the workflow is processed as customized by the at least one sub workflow. Non-limiting examples of tangible result produced by the customized workflow include handling a telephone call and ingesting digital media.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

One or more embodiments of the invention may offer one or more of the following technical benefits: end users can create sub flows that ate part of a larger workflow; the end users' sub flow only affects workflows that are executed on behalf of the end user; end users can influence, at run time, the outcome of an instance of the process; and/or end users are constrained in terms of the options, so that the outcome is predictable. Additional potential technical benefits may include one or more of the following:
Users are can pick and use any services available to them to customize their workflow experience.
Broader range of workflow customization than the known approach of letting user customize some preference.
When the service provider adds new services to the user palette, they become available right away to the user, without a need to modify the main workflow.
These sub flows are checked for verification and/or validation
Users or groups might have different capabilities based on their privilege level (authentication)

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary embodiment of a system, according to an aspect of the invention;

FIG. 2 shows a screen of a prior art GUI with a workflow to be modified, according to an aspect of the invention, prior to making access points visible;

FIG. 3 shows a screen of an exemplary inventive GUI, with sub workflow access points;

FIG. 4 shows several exemplary sub flows that may be inserted at an access point, according to further aspects of the invention;

FIG. 5 shows a first sub flow in detail;

FIG. 6 shows a second sub flow in detail;

FIG. 7 shows a flow chart of exemplary method steps, from a “system” or “service provider” point of view, according to another aspect of the invention;

FIG. 8 shows a flow chart of exemplary method steps, from an “end user” point of view, according to a still further aspect of the invention; and

FIG. 9 depicts a computer system that may be useful in implementing one or more aspects and/or elements of the present invention.

### DETAILED DESCRIPTION OF PREFERRED EMBODIMENTS

One or more embodiments of the invention allow parties, such as end users, to have control, and within system level defined properties, to devise their own sub flows in workflows that are related to the end users.

In a non-limiting example, a customer or client (referred to for convenience as a user or end user) uses a digital media content processing service, via an interface. In another example, the end user accesses a service pertaining to a telephone interface. The end user is allowed to have some input into the definition of the interface, that is, how the call is handled or how the content is ingested. Note that these are non-limiting examples, as workflows exist in a variety of settings, and techniques of the invention can be applied in several different domains.

In one or more embodiments, the end user access an end user graphical user interface (GUI) and checks what predefined “access points” are available and what information and/or content is there (that is, at the given access point). In some instances, a telephone company (“telco”) has ultimate control of a given workflow. However, within the workflow, via the aforementioned access points, there are one or more opportunities for the customer (end user) to customize his or her own sub workflows at the access points. At these points, the end user inserts a sub workflow just for him or her. For example, a different end user could insert a different sub workflow at the same access point, such that this different end user would experience a different overall flow. It should also be noted that while it was just stated that the sub workflow was “just for him or her,” in one or more instances, a user can not only define his own workflow, but can also decide to use predefined workflows established by other users joining a group. Thus, in a broader sense, aspects of the invention ensure that a ‘personal’ or ‘group’ subflow is executed for a particular user.

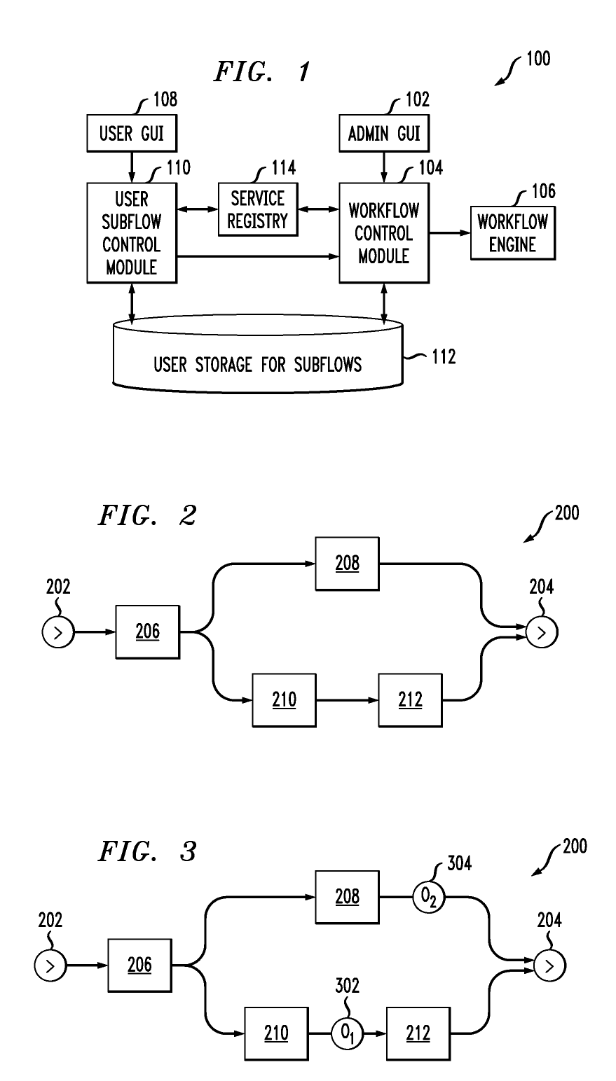

With attention now to FIG. 1, an exemplary system 100 includes a GUI 102 for use by an administrator, a workflow control module 104, and a workflow engine 106. Note that an exemplary preferred embodiment will be described with regard to a service provider and an end user, but in a more general case, can involve simply a first party and a second party. Elements 102, 104, and 106 may be under the control of a service provider. Also included are an end user GUI 108, a user sub flow control module 110, and user storage for sub flows 112. The workflow of interest is implemented by engine 106 under the control of module 104. The aforementioned administrator sets up, modifies, and controls blocks 104 and 106 from GUI 102. Blocks 102, 104, and 106 can be implemented using known current techniques. Given the teachings herein, elements 108, 110, 112 can be implemented to interface with conventional blocks 102, 104, 106.

Examples of user GUI 108 are given below with respect to FIGS. 2-6. Sub flows can be constructed using module 110 and GUI 108, and stored in storage 112. Stored sub flows in module 112 can be accessed by module 110 for validation and insertion in main workflow for a particular user, and by module 104 for execution at run time.

Non-limiting examples of workflows that can be defined, at least in part, by an end user include behavior of incoming calls and/or behavior of content ingestion (to be discussed further below). In one or more embodiments, the end user accesses the system and effectuates the customization by employing web-based GUI 108. The end user can employ the GUI to manage his or her account, and to build the aforementioned sub workflows for insertion at the access points. The sub workflow can be based, for example, on one or more services that are available at the given insertion point, which may be presented to the end user by, for example, use of a menu. The available services may then be sequenced in a given order to create the sub workflow. Thus, in one or more embodiments, an end user interacts with a service by using a telephone interface, and is given the opportunity to modify the flow of the telephone interface by using the aforementioned GUI to insert sub workflows at access points. The user interface is not limited to a graphical user interface, and could be, for example, text based or voice activated. Furthermore, sub flows could be predefined and users may just select one of them or sequence one or more with other available services.

In addition to telephone call flows, a variety of other types of workflows can be modified by an end user in accordance with techniques of the invention. A non-limiting example is ingestion of content into a multimedia service, where an end user has created multimedia content and wishes to watermark it or edit it in some way; for example, audio fade-in and/or fade-out, video opening or closing credits, banners, commentary, and the like. As a non-limiting example, consider a video sharing website where users can upload, view and share video clips, such as the YOUTUBE™ web site offered by Google, Inc. Instead of a pure “black box” approach, the opportunity for sub workflow insertion at access points could be provided by the host of such a site to allow customization, such as the aforementioned watermarking, audio fade-in and/or fade-out, video opening or closing credits, banners, commentary, and so on. Aspects of the invention could be applied to ingestion of other types of content besides videos; for example, still photos.

The aforementioned telco and video sharing web site are non-limiting examples; in general, a service provider is in charge of a workflow that is to be used by an end user. An end user of the workflow is allowed to modify portions of the workflow, at the aforementioned access points, resulting in a customized view or instance of the workflow just for that particular end user.

FIG. 2 shows an existing workflow 200 which may be graphically displayed by GUI 108. Flow 200 includes start 202, end 204, and a plurality of steps 206, 208, 210, 212. FIG. 2 shows a prior art display. As seen in FIG. 3, according to an aspect of the invention, there are one or more access points 302, 304. The user selects an access point. The access points may be displayed upon first viewing the workflow, in response to a command, by mousing over the workflow, and so on.

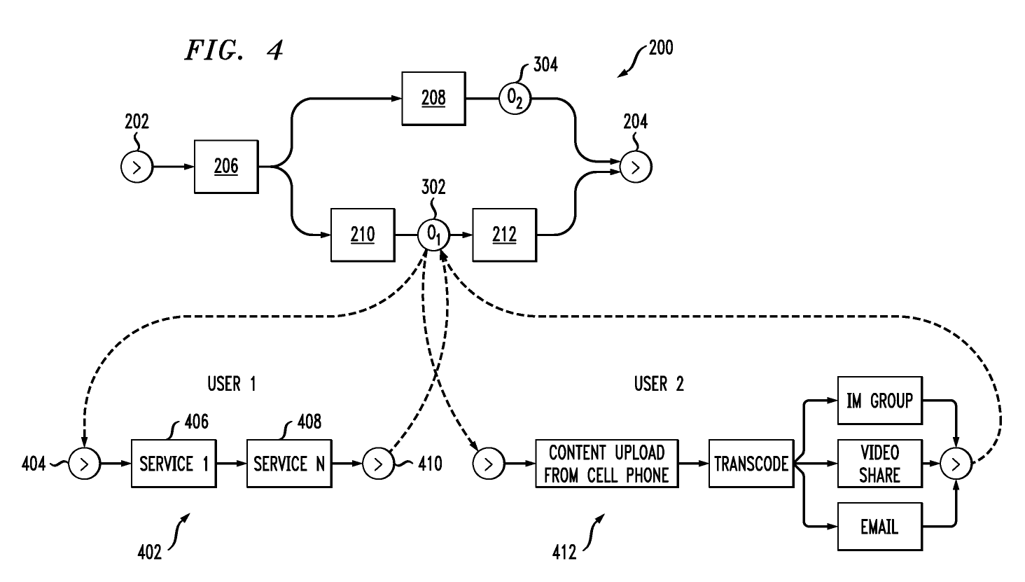

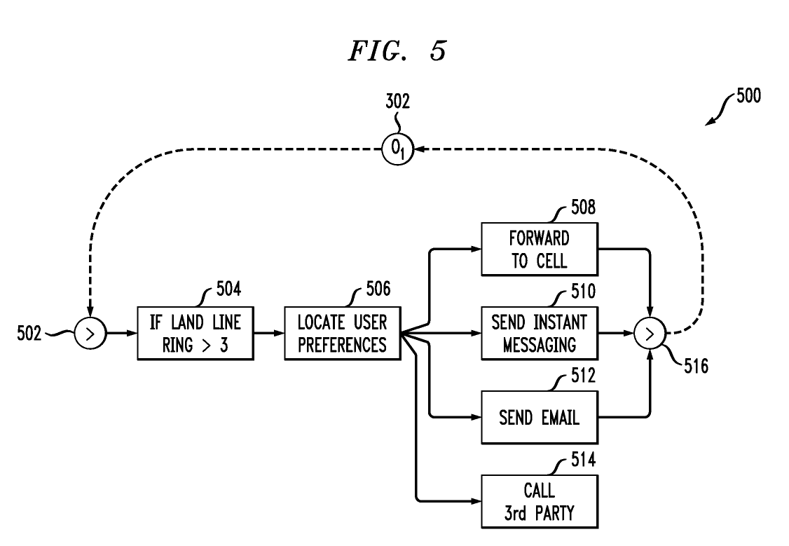

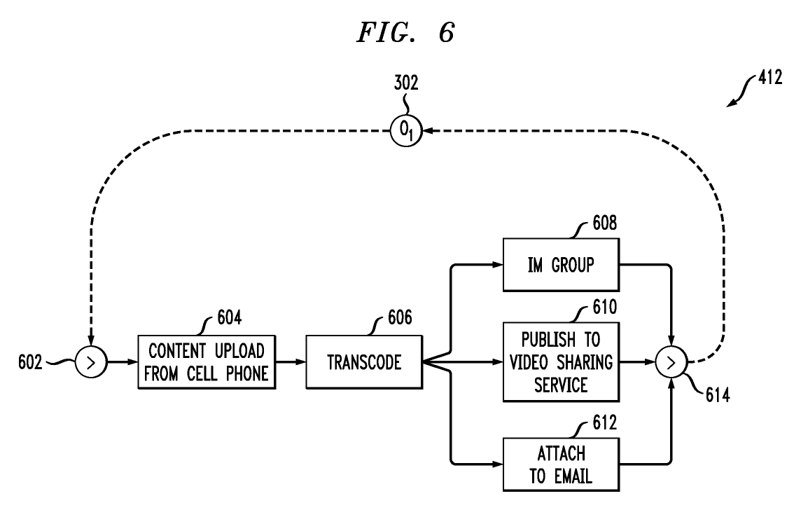

With reference to FIG. 4, the user opens another panel and “draws” the sub flow using the GUI tool. In one or more embodiments, the user actually constructs flow logic, as opposed to merely accessing a customizable profile. In FIG. 4, a first user has constructed sub flow 402, which begins at 404, accesses services 1 through N, as per blocks 406 and 408, and which finishes at 410. A second user has constructed sub flow 412, to be discussed in detail with regard to FIG. 6.

In each case, on submission, the sub flow is validated; for example, by user sub flow control module 110. The end user can re-edit (create, read, update and delete (CRUD)) the sub flow anytime, as indicated by the double-headed arrow joining blocks 110 and 112 in FIG. 1.

Returning to the specific telco example, the telco may provide a web page where the end user logs in to access GUI 108 and selects a workflow 200, or a sub flow thereof, for customization; for example, a sub flow for handling incoming calls. Employing the GUI, the end user views a menu of one mote services that may be available for customization purposes; such as a call forwarding module, a decision module, and so on. The end user may be afforded a “canvas” on the GUI for creating the customized (sub) workflow, and may access and connect one or more available modules. Once the sub flow is finished, the end user will then submit the sub workflow. The aforementioned verification process can then be carried out on the sub workflow, to make sure that it is workable, and if the verification is passed, the sub workflow can be instantiated. This process may be carried out, for example, by submitting the sub workflow from the end user back to a server. The server may have program logic to determine the validity of the sub workflow. If there are errors or inconsistencies in the sub workflow, the logic on the server may return an error message.

By way of example and not limitation, the server may run blocks 104, 106, and 110, and storage 112 may also reside on the server. Block 102 may be on the service provider side. Block 108 may be a standard web browser on the end user's client (thin client), with most of the logic on the server, or it can be a thick client (containing some logic) which the user has to install.

With reference to FIG. 5, an exemplary sub flow 500 for a telephony application is depicted. In this case, after beginning at 502, block 504 determines if a land line has rung more than three times without being answered. If so, block 506 locates user preferences, which may include, for example, forwarding to a cell phone as in block 508, sending an instant message as at block 510, sending an e-mail as at block 512, or calling a third party (e.g., the end user's “back up”), at block 514. The sub flow ends at 516.

FIG. 6 shows an example of the aforementioned sub workflow 412 for content ingestion. After beginning at 602, block 604 involves uploading of content from a cell phone (for example, still photos or videos). At block 606, the content is transcoded to an appropriate format, for further action, such as: attachment to an e-mail, at block 612; publication to a video-sharing service, such as the aforementioned YOUTUBE™ service, at block 610; and/or an Instant Messaging (IM) group, as at block 608 (a group of people who would receive an IM notification). The sub flow ends at 614.

The logic on the server may be implemented, for example, using a workflow engine 106 operated by the service provider. Current workflow engines may be modified by the skilled artisan to carry out the verification and other processes described herein, given the teachings herein. For example, a workflow engine can be modified to identify a particular end user and to call his or her customized sub workflows for insertion at the aforementioned access points. It should again be pointed out that the sub workflows are only insertable by the end user (or, a group associated with the end user, but not all the users) at specific constrained locations, such as the aforementioned access points. Further, in one or more embodiments, the workflow and the customized sub workflows are represented in business process execution language (BPEL) and the logic on the server, which may be implemented by the modified workflow engine, analyzes and processes the BPEL representations of the workflow and sub workflows.

Note that the aforementioned GUI is a non-limiting example of a technique for affording the end user the opportunity to customize sub workflows. Other examples include scripting languages, where an end user may be given the opportunity to insert one or more sequences of instructions at one or more predefined access points; and interactive voice response (IVR) systems, where the end user may construct a sub flow by voice interaction.

In some instances, different sub workflows may be used for the same end user at the same access point, depending on other factors such as, for example, the time of day and/or location. For example, if an end user is traveling in a different location, he or she may invoke a voice mailbox routine instead of a ring, so as not to be disturbed at night (in the time zone where he or she is traveling) for calls that would be during waking hours if the user were not traveling. The particular sub flow to be executed can be defined at run time, based on (i) one or more sub flows received from the end user and corresponding to a given access point, as well as (ii) one or more additional factors, such as time of day, geographic location of the end user, and so on.

Thus, the sub flow, personal sub flow, micro flow, or sub micro flow (these terms are intended to be substantially interchangeable) defined by the user may, for example, be time dependent (for example, “from 8 am to 11 am, have this behavior; from 11 am to 1 pm, handle calls differently”), content dependent, caller ID dependent, or location dependent (e g., “if caller ID is blocked, ignore call,” “if user's home ID is shown, forward call to cell”).

It will be appreciated that a user profile with a personalized and/or personalizable sub workflow may be maintained at and/or by a service provider. Role-based customizable profiles may be maintained (for example, by a manager or at a management level). Aspects of the invention thus provide a method for allowing end users to have control, within system level defined properties, to devise their own sub flows in workflows that ate related to the end users. Within the overall workflow, points can be pre-defined (access points) where the end user might insert a single service call or a sequence of services calls (a sub flow). In order to achieve this, the end user employs a user interface, such as GUI 108, to facilitate the definition of the sub flows. The sub flows are then checked and if compliant, they are integrated to the main workflow at runtime. At runtime, once an access point is reached, the sub flow is run, if it is valid and enabled for the user of a set of users (as a consequence, the main workflow can fork as many ways as there are validated sub flows for that access point).

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor; by sending appropriate data or commands to cause or aid the action to be performed.

Thus, referring back to FIG. 1 again, an exemplary system 100 for processing workflows is depicted. The workflow incorporates sub flows, stored in storage 112, which are selected, upon reaching an access point, based on end user identification. The system includes a sequencing engine (such as workflow engine 106). Also included is a selector, which picks the correct sub flow at a given access point, based on the end user identification. This functionality may be carried out, for example, by workflow control module 104. The user is identified, for example, by providing his or her credentials when using the service implemented by the main workflow. Such credentials are available to module 104, which uses the user ID to access the subflow from storage 112 to be invoked at the access point when the workflow engine 106 runs.

An end user interface, such as GUI 108, facilitates the definition of user-specified sub flows. A set of available services, for example, media processing services, are registered and presented to the end user by GUI 108 when the end user constructs the sub flow. The services may be registered, for example, in a service registry 114 available to the user subflow control module 110 and to the workflow module 104. In some instances, the available services are constrained by the end user properties; for example, a manager is allowed one set of choices, a consumer another set, and so on. Available services might also be based on user preferences—such as showing only services that deal with picture editing or call transfers.

As noted, the end user interface can be based on GUI 108, but an IVR system, a scripting language, or other techniques can be employed. The user input can thus be received from a variety of devices, such as a telephone (mobile or land line), personal digital assistant (PDA), personal computer (PC) and the like. In one or more embodiments, the behavior of the sub flow for an end user can depend on user and or system events, such as location of the end user, time of day, and so on. As noted, each end user can construct his or her own sub flows, which do not change the underlying workflow; a separate instance of the flow is created by accessing the correct sub flow, based on user ID, at each access point. In some cases, an end user may make a sub flow available to other end users; this could even be done as a service.

In one or more implementations of the invention, work items are not pre-defined by the workflow; rather, the end user is permitted to configure them; indeed, sub flows can be customizable at the user level and need not be pre-defined. Additionally, in one or more embodiments of the invention, the specific sub flow being called as part of a parent workflow can be dependent on variables (such as time of the day, location, and the like) and can be dynamically modified at runtime. In one or more instances, the user is presented with a configurable sub workflow, and can pick and choose from a number of pre-defined tasks to create a sub workflow. Additionally, in one or more embodiments of the invention, the sub workflow behavior can be dependent on variables (such as time of the day, location, etc) and can be dynamically modified at runtime.

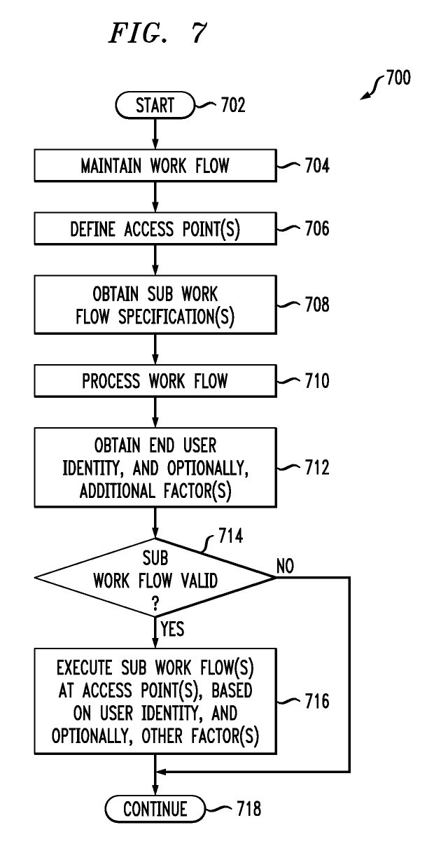

Attention should now be given to FIG. 7, which presents a flow chart 700 of exemplary method steps, according to an aspect of the invention, from a “system” or “service provider” point of view (for example, the point of view of the telco or video sharing web site). After beginning at block 702, step 704 includes the service provider maintaining a workflow. Step 706 includes defining, in the workflow, at least one access point. Step 708 includes obtaining, from a user, a specification of at least one sub workflow, for insertion at the access point. Step 710 includes the service provider processing the workflow.

Step 712 includes obtaining, by the service provider from the end user; an indication of identity of the end user. Optional but preferred step 714 will be discussed below. Step 716 includes the service provider, during the processing of the workflow, executing the sub workflow when the access point is reached, based (at least) on the indication of identity of the end user (that is, pick the sub flow to run based on the ID of the user that the main workflow is being executed for).

Optional decision block 716 includes validating the sub workflow. As indicated by the “YES” and “NO” branches, the sub workflow is executed only when the validating is affirmative. Processing continues at block 718.

As noted elsewhere, the workflow and/or the sub workflow can be defined, for example, in BPEL. Non-limiting examples of the types of processes that can be represented by the workflow include, as discussed elsewhere, a manner of handling a telephone call and/or a manner of ingesting digital media. Step 716 is, as noted, carried out based on the user identity obtained in step 712, but may be based on one or additional factors as well, such as time, location, and the like, as discussed elsewhere herein.

Step 708 can be carried out in a variety of ways; as discussed elsewhere, non-limiting examples include via an interactive voice response system, and/or via receiving, from the user, the specification of the sub workflow in a scripting language. In a preferred approach, the aforementioned GUI is employed. In general, the steps of FIG. 7 can be carried out in a number of ways; one preferred approach is to employ the system of FIG. 1.

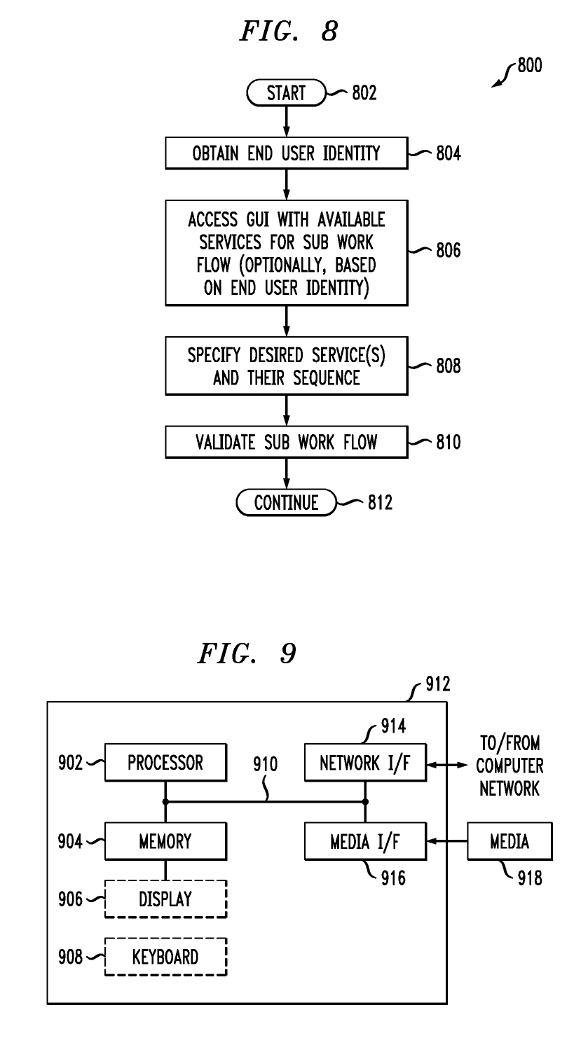

FIG. 8 presents a flow chart 800 of exemplary method steps, according to an aspect of the invention, from an end user point of view. After beginning at block 802, step 804 includes obtaining the end user identity (essentially step 712 discussed above). Step 806 includes accessing a graphical user interface (which can be, for example, provided to the user by the service provider). The graphical user interface offers the user a plurality of services. In some instances, the plurality of the services offered to the user depend on the identity of the user. In step 808, the user specifies the desired services and their sequence; the sequence specifies the sub workflow. This specification is received from the user by the service provider. Step 810 includes validating the sub workflow (essentially similar to step 714). Processing continues at block 812.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 9, such an implementation might employ, for example, a processor 902, a memory 904, and an input/output interface formed, for example, by a display 906 and a keyboard 908. The term “processor” as used herein is intended to include any processing device, such as, for example, one that includes a CPU (central processing unit) and/or other forms of processing circuitry. Further, the term “processor” may refer to more than one individual processor. In connection with FIG. 9, the term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 902, memory 904, and input/output interface such as display 906 and keyboard 908 can be interconnected, for example, via bus 910 as part of a data processing unit 912. Suitable interconnections, for example via bus 910, can also be provided to a network interface 914, such as a network card, which can be provided to interface with a computer network, and to a media interface 916, such as a diskette or CD-ROM drive, which can be provided to interface with media 918. FIG. 9 is illustrative of the servers and other computers mentioned herein.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 918) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device). Examples of a computer-readable medium include a semiconductor or solid-state memory (for example memory 904), magnetic tape, a removable computer diskette (for example media 918), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 902 coupled directly or indirectly to memory elements 904 through a system bus 910. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 908, displays 906, pointing devices, and the like) can be coupled to the system either directly (such as via bus 910) or through intervening I/O controllers (omitted for clarity).

Network adapters such as network interface 914 may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. In some instances, BPEL is employed. The program code may execute entirely on the users computer; partly on the user's computer; as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/ox flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other, implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
maintaining, by a first party, a workflow;
defining, in said workflow, at least one access point;
obtaining, from a second party, a specification of at least one sub workflow, for insertion at said access point;
processing, by said first party, said workflow;
obtaining, by said first party from said second party, an indication of identity of said second party; and
during said processing of said workflow, executing said sub workflow, by said first party, when said access point is reached, based on said indication of identity of said second party;
whereby said processing of said workflow produces a customized result for said second party.

2. The method of claim 1, wherein said first party comprises a service provider and said second party comprises an end user.

3. The method of claim 2, further comprising the additional step of validating said sub workflow, wherein said sub workflow is stored and made available for processing only when said validating is affirmative.

4. The method of claim 2, wherein said workflow and said sub workflow are defined in business process execution language.

5. The method of claim 2, wherein said obtaining said specification comprises the sub-steps of:
providing a graphical user interface to said user; said graphical user interface offering said user a plurality of services; and
receiving from said user, via said interface, a sequence of said services, said sequence specifying said sub workflow.

6. The method of claim 5, wherein said plurality of said services offered to said user depend on an identity of said user.

7. The method of claim 2, wherein said obtaining said specification is carried out via an interactive voice response system.

8. The method of claim 2, wherein said obtaining said specification is carried out by receiving, from said user, said specification of'said sub workflow in a scripting language.

9. The method of claim 2, wherein said obtaining said specification is carried out by specification of said sub workflow based on selection of pre-defined subflows.

10. The method of claim 2, wherein said obtaining said specification is carried out by sequencing of pre-defined subflows with a plurality of services.

11. The method of claim 2, wherein said executing of said sub workflow is based on at least one additional factor besides said identity of said user.

12. The method of claim 11, wherein said at least one additional factor is time.

13. The method of claim 11, wherein said at least one additional factor is location.

14. The method of claim 2, wherein said workflow specifies a manner of handling a telephone call, and wherein said customized result comprises handling said telephone call in accordance with said workflow as customized by said at least one sub workflow.

15. The method of claim 2, wherein said workflow specifies a manner of ingesting digital media, and wherein said customized result comprises ingesting said digital media in accordance with said workflow as customized by said at least one sub workflow.

16. The method of claim 2, wherein said sub workflow is shared by said end user with a group of associated users that is less than all users of said workflow.

17. A computer program product comprising a computer useable medium including computer usable program code, said computer program product including:
computer usable program code for maintaining, by a first party, a workflow;
computer usable program code for defining, in said workflow, at least one access point;
computer usable program code for obtaining, from a second party, a specification of at least one sub workflow, for insertion at said access point;
computer usable program code for processing, by said first party, said workflow;
computer usable program code for obtaining, by said first party from said second party, an indication of identity of said second party; and
computer usable program code for, during said processing of said workflow, executing said sub workflow, by said first party, when said access point is reached, based on said indication of identity of said second party;
whereby said processing of said workflow produces a customized result for said second party.

18. The computer program product of claim 17, wherein said first party comprises a service provider and said second party comprises an end user.

19. The computer program product of claim 18, further comprising computer usable program code for validating said sub workflow, wherein said sub workflow is stored and made available for processing only when said validating is affirmative.

20. The computer program product of claim 19, wherein said workflow specifies a manner of handling a telephone call, and wherein said customized result comprises handling said telephone call in accordance with said workflow as customized by said at least one sub workflow.

21. The computer program product of claim 19, wherein said workflow specifies a manner of ingesting digital media, and wherein said customized result comprises ingesting said digital media in accordance with said workflow as customized by said at least one sub workflow.

22. A system comprising:
a memory; and
at least one processor, coupled to said memory, and operative to:
maintain, by a first party, a workflow;
define, in said workflow, at least one access point;
obtain, from a second party, a specification of at least one sub workflow, for insertion at said access point;
process, by said first party, said workflow;
obtain, by said first party from said second party, an indication of identity of said second party; and
during said processing of said workflow, execute said sub workflow, by said first party, when said access point is reached, based on said indication of identity of said second party;
whereby said processing of said workflow produces a customized result for said second party.

23. The system of claim 22, wherein said first party comprises a service provider and said second party comprises an end user.

24. A system comprising:
means for maintaining, by a first party, a workflow;
means for defining, in said workflow, at least one access point;
means for obtaining, from a second party, a specification of at least one sub workflow, for insertion at said access point;
means for processing, by said first party, said workflow;
means for obtaining, by said first party from said second party, an indication of identity of said second party; and
means for, during said processing of said workflow, executing said sub workflow, by said first party, when said access point is reached, based on said indication of identity of said second party;
whereby said processing of said workflow produces a customized result for said second party.

25. The system of claim 24, wherein said first pasty comprises a service provider and said second party comprises an end user.
